(19) United States
(12) Patent Application Publication
(10) Pub. No.: US 2021/0255838 A1
(43) Pub. Date: Aug. 19, 2021

(54) EXTENSIBLE USER DEFINED FUNCTIONS VIA OBJECT PROPERTIES

(71) Applicant: Microsoft Technology Licensing, LLC, Redmond, WA (US)

(72) Inventors: Gregory Scott Lindhorst, Seattle, WA (US); Yasser Elsayed Mohamed Shaaban, Seattle, WA (US); Shantanu Kiran Pakhare, Redmond, WA (US); Hemanth Kumar, Snohomish, WA (US); Lee McCall Saltzman, Bellevue, WA (US)

(21) Appl. No.: 16/791,707

(22) Filed: Feb. 14, 2020

(51) Int. Cl. G06F 8/34

(52) U.S. Cl. CPC G06F 8/34

(57) ABSTRACT

Embodiments of extending properties of objects in a designer tool for generating applications are disclosed therein. In one embodiment, a method includes receiving a formula as an input value to a property of an instance of an object surfaced via a graphical user interface of a designer tool. The property corresponds to a function having an input parameter to the function, and the received formula includes the input parameter. The method further includes in response to receiving the formula as the input value to the property, automatically deploying programming codes in the application to incorporate the received formula in order to extend functionality of the instance of the object.

### BACKGROUND

Cloud computing utilizes virtual machines, containers, virtual switches, and other suitable software facilities hosted on remote servers to process, manage, or store user data. A computer network can interconnect the software facilities on the remote servers as nodes to form a computing fabric. During operation, one or more nodes of the computing fabric can cooperate with one another to provide a distributed computing environment that facilitates execution of suitable user applications in order to provide desired computing services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Cloud computing can offer a wide variety of computing services to users. For example, a user can utilize a hosted computing service for performing calculation, threshold detection, data storage, or other tasks. Cloud computing can also allow users to create customized applications or “apps” that manage, control, or otherwise interact with various computing or communication services. For instance, a user can create an app that is configured to perform a custom calculation on data stored in a cloud storage location according to certain defined formulas, generate alerts based on calculation results and preset thresholds, and/or perform other suitable tasks.

In certain programming environments, creating apps often requires users to have levels of computer programming skills and knowledge, such as knowing the JavaScript language, as well as some understanding of application programming interfaces (“APIs”) used in various computing platforms. As such, creating apps can be difficult for vast majority of users who do not have such skills or knowledge. To allow creation of apps by such users, designer tools based on graphical object-oriented programming have been developed. Typically, such a designer tool can provide a graphical user interface that allows a user to graphically select a data source, provide logic to be applied to user data stored in the specified data sources, and configure data output of processing results based on the selected logic. For example, a user can specify data contained in a spreadsheet stored in a cloud storage location as a data source for certain fields in an app and specify a view of the data from the spreadsheet as output in the app by selecting labels or other suitable interface elements. One example of such a designer tool is Power Apps® provided by Microsoft Corporation of Redmond, Wash.

When creating apps using such designer tools, various objects can be created in order to reduce repetition of efforts, improve consistency of appearance, or for other purposes. For example, a model object (e.g., a “component” as referred to in Power Apps®) can be generated in an app to include multiple subordinate objects or “sub-objects,”, such as images, input/output fields, labels, buttons, etc. The model object can then be reused as a template in multiple locations throughout the app or exported to be used in additional apps. One advantage of utilizing model objects is that if a change to instances of a model object is needed, only a change to the template of the model object is sufficient to effect changes to all the instances of the model object throughout the app. In addition, in certain circumstances, a model object may be standardized, for instance, by an administrator or developer for use by multiple additional users or app makers to ensure consistency of the model object or for other purposes.

Typically, a model object can include certain properties that are configured to receive data from or output data to the app containing instances of the model object. For example, the model object can include a property (e.g., “Title”) that is of an input type configured to accept data of a string type. As such, an instance of the model object can accept a user input from the app that specifies the “Title” property to have a value of “Page One.” Another instance of the same model object can accept another user input from another page of the app with a value of “Page Two.” Similarly, variable values from inside an instance of the model object can be passed to the app using properties of an output type.

Though the input and output properties of the model object can allow passing of variable values between the app and instances of the model object, a user may still need certain programming skills and knowledge in order to extend the model object with custom program functions in the app. For example, to implement a function in the app to extend the model object, a user may need certain skills and knowledge of declaring input parameter(s) for a function, passing values of the declared input parameter(s) to the function, creating formulas in the function incorporating the input parameter(s), and receiving data of processing results of the formulas back from the function. Such requirements can reduce usability of the designer tool as well as efficiencies of creating new apps by vast numbers of users.

Several embodiments of the disclosed technology can address aspects of the foregoing difficulty by providing a designer tool that extends a property of a model object or other suitable types of object in an app. In certain implementations, a property of an object can be defined in the object scope to include one or more input parameters to the property, an optional default formula, and an output type. During app development, the one or more input parameters can be exposed to a user operating in an app scope and allow the user to program or reprogram the property of the instance by simply providing a formula that incorporates the one or more input parameters of the property. For example, the user can provide a formula using the exposed one or more input parameters and/or other application scope variables (referred to herein as “global variables). In turn, the designer tool can be configured to incorporate the received formula as an extension to the instance of the model object.

In certain implementations, a model object with such a property with one or more input parameters can be defined by a developer, administrator, or a user via a graphical user interface. For instance, a developer can specify a name (e.g., “Calc”) of the property for a model object and define one or more input parameters (e.g., P1 and P2) in the object scope of the model object. The developer can also specify which of the one or more input parameters in the object scope can be accessed from and thus exposed to a higher-level scope through a custom function as parameters, such as an app scope in certain implementations. For example, the developer can specify that both P1 and P2 can be accessed from a higher-level scope. Optionally, the developer can also provide a default value (e.g., 100) or a default formula for the defined property, e.g., “P1*P2.”

Upon receiving the foregoing information of the model object, the designer tool can be configured to compile the model object with the property into a property definition package based on the received information. In one implementation, the designer tool can be configured to automatically declare a function corresponding to the property, identify the one or more input parameters as values needed to be passed to the function for evaluation, optional actions to be performed within the function, and one or more values to be returned when the function is called. The following are example programming codes for a function corresponding to the example “Calc” property above:

function Calc(P1 as Double, P2 as Double) as Double Calc=P1*P2 end function

As shown above, the declared function has a name “Calc” that takes two input parameters, i.e., “P1” and “P2” both of which are Double numbers; and returns a Double number that equals to P1*P2, which is a default formula.

The compiled property definition package can then be reused in the designer tool for creating additional instances of the model object. A user creating the additional instances of the group object can readily and efficiently extend functionality of the instances by providing a formula incorporating the one or more input parameters without concerning about function and/or variable declarations, passing arguments, or other function related programming tasks. For instance, in the example above, a user can create an instance of the model object based on the compiled property definition package by, for example, issuing a command in the designer tool to insert an instance of the model object onto a graphical user interface (or “canvas”) of an app or a page of the app. In response, an interface element representing the inserted instance of the model object is surfaced on the graphical user interface.

Upon detecting a selection of the inserted instance of the model object, the designer tool can be configured to provide a property bar, a dropdown menu, a popup window, or other suitable types of interface elements for accessing properties of the instance of the model object. For example, via a property bar, the user can select “Calc” from a dropdown menu and provide a new formula for the “Calc” instance, e.g., (P1*P2)/2, to an input field. In response, the designer tool can be configured to extend the instance of the model object with the received formula (i.e., “(P1*P2)/2”) after being translated into a full function. As such, the corresponding function to “Calc” in the above example can be modified as follows:

function Calc(P1 as Double, P2 as Double) as Double Calc=(P1*P2)/2 end function

In certain embodiments, the received formula is not passed to the model object, and the model object is not modified. Instead, the model object provides an interface definition that the formula conforms to in order to be called back from the model object. In other embodiments, the received formula can be implemented in the model object using object scope variables or input parameters. The app can then call the function at app scope, pass values from app scope as input parameters, and cause the function incorporating the formula to be executed in the model object, which can then return a value to the app scope.

The model object can also allow the user to create additional instances of the model object with different user-supplied formulas. For instance, in the example above, the user can insert another instance of the model object on the same or different page of the app. The user can then provide an additional formula, e.g., “P1+P2” to the designer tool for the property. In response, the designer tool can be configured to associate the received formula to the corresponding property. As such, the corresponding function to “Calc” can be modified as follows:

function Calc(P1 as Double, P2 as Double) as Double Calc=P1+P2 end function

As such, using one model object, the user can create multiple instances of the model object with the same or different formulas without concerning programming details of the underlying function.

Several embodiments of the disclosed technology can thus allow users to extend functionalities of properties of objects in an app via modification of properties using object scope input parameters. Instead of requiring a user to have certain programming skills or knowledge of declaring a function, passing arguments to the function, and receiving results back from the function, the user simply inputs a desired formula by selecting the exposed input parameters of the property in order to effect a desired function in the object scope. As such, writing codes in the designer tool may be avoided in order to implement functions by the users.

### BRIEF DESCRIPTION OF THE DRAWINGS

FIG. 1 is a schematic diagram illustrating a computing system configured to provide cloud services in accordance with embodiments of the disclosed technology.

FIG. 2 is a schematic diagram illustrating certain hardware/software components of the computing system of FIG. 1 in accordance with embodiments of the disclosed technology.

FIG. 3 is a block diagram illustrating hardware/software components of a designer tool suitable for generating apps to be executed in the computing system of FIG. 1 in accordance with embodiments of the disclosed technology.

FIGS. 4A and 4B are schematic diagrams of a graphical user interface suitable for a designer tool of FIG. 3 configured in accordance with embodiments of the disclosed technology.

FIGS. 5A and 5B are flowcharts illustrating processes of extending properties of objects in an app in accordance with embodiments of the disclosed technology.

FIG. 6 is a computing device suitable for certain components of the computing network in FIG. 1.

### DETAILED DESCRIPTION

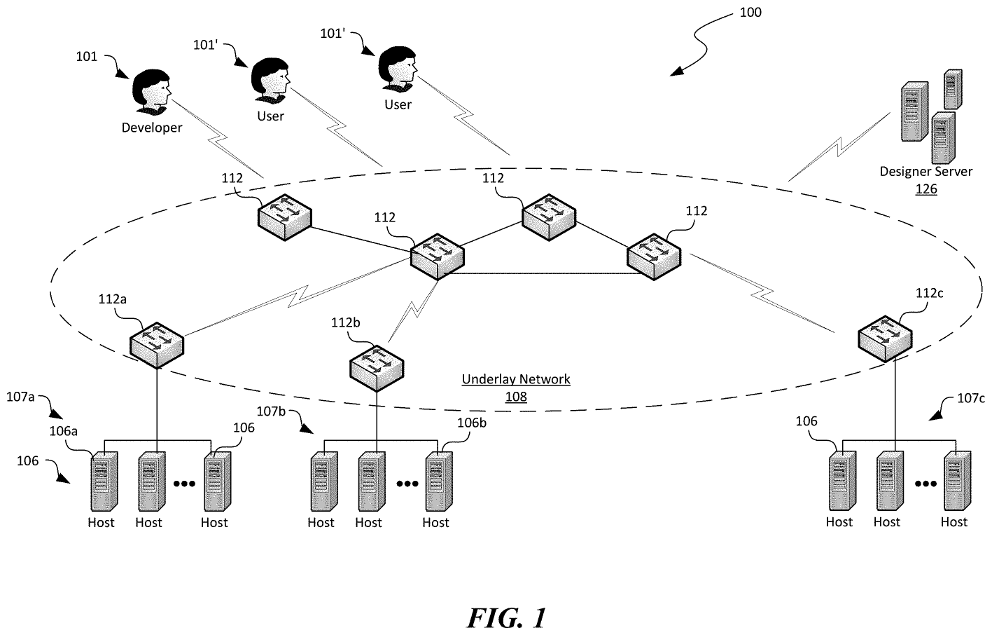

Various embodiments of computing systems, devices, components, modules, routines, and processes related to designer tools for extending properties of objects in an app are described below. In the following description, example software codes, values, and other specific details are included to provide a thorough understanding of various embodiments of the present technology. A person skilled in the relevant art will also understand that the technology may have additional embodiments. The technology may also be practiced without several of the details of the embodiments described below with reference to FIGS. 1-6.

As used herein, the term “computing system” generally refers to an interconnected computer network having a plurality of network nodes that connect a plurality of servers or hosts to one another or to external networks (e.g., the Internet). One example of a computing system is a cloud computing datacenter configured to provide certain cloud services. The term “network node” generally refers to a physical network device. Example network nodes include routers, switches, hubs, bridges, load balancers, security gateways, or firewalls. A “host” generally refers to a physical computing device configured to implement, for instance, one or more virtualized computing devices or components, or other suitable functionalities. For example, a host can include a server having a hypervisor configured to support one or more virtual machines or other suitable virtual components.

A computing network can be conceptually divided into an overlay network implemented over an underlay network. An “overlay network” generally refers to an abstracted network implemented over and operating on top of an underlay network. The underlay network can include multiple physical network nodes interconnected with one another. An overlay network can include one or more virtual networks. A “virtual network” generally refers to an abstraction of a portion of the underlay network in the overlay network. A virtual network can include one or more virtual end points referred to as “tenant sites” individually used by a user or “tenant” to access the virtual network and associated computing, storage, or other suitable resources. A tenant site can host one or more tenant end points (“TEPs”), for example, virtual machines. The virtual networks can interconnect multiple TEPs on different hosts. Virtual network nodes in the overlay network can be connected to one another by virtual links individually corresponding to one or more network routes along one or more physical network nodes in the underlay network.

As used herein, an “object” generally refers to a combination of one or more of variables, functions, and data structures. In certain implementations, an object can be represented and/or associated with graphical elements on a graphical user interface. For example, an object can include an image, an input field, an output field, or other suitable graphical elements. In other implementations, an object can also include sub-objects such as one or more of images, fields, labels, button, or other graphical elements grouped into an overall object. A definition of the grouped sub-objects can be used as a template to create multiple instances of the object. Thus, multiple instances of the same object can co-exist in a single application with respective variables, functions, and data structures.

Also used herein, a “property” of an object generally refers to an attribute of the object. Properties can be of different property types. For instance, a property can be of an input type that is configured to receive a value from an entity outside of the object. Another property can be of an output type that is configured to output a value from the object to an entity outside of the object. In accordance with embodiments of the disclosed technology, a property can include one or more input parameters that are surfaced in a designer tool to a user for composing or deploying a function corresponding to the property in order to extend functionality of a corresponding instance of an object, as described in more detail below with reference to FIGS. 1-6.

An application can include multiple objects individually belonging to different scopes. As used herein, a “scope” or “variable scope” generally refers to a boundary of visibility of a variable or input parameter. In one example, a variable can have a global scope in an application (referred to herein as “application scope”). As such, every object or parts thereof can utilize such a global variable. In another example, a variable can be visible only inside an object (referred to herein as “object scope”). As such, the variable is only visible to other variables or functions inside or internal to the object. Further used herein, a “formula” generally refers to an expression of mathematical operations or computer actions upon a specific variable or input parameter value.

In conventional computing systems, creating cloud service apps can have requisite levels of computer programming skills and/or knowledges. As such, creating such apps can be difficult for a large number of users without such skills or knowledges. Several embodiments of the disclosed technology can address aspects of the foregoing difficulty by providing a designer tool that implements a property incorporating input parameters for an instance of an object in an app. As such, the designer tool can expose input parameters of the property in the object scope to a user operating in an app scope and allow the user to provide a formula to the instance using the input parameters of the property. In turn, the designer tool can associate a function corresponding to the formula with the property of the instance of the object, as described in more detail below with reference to FIGS. 1-6.

FIG. 1 is a schematic diagram illustrating a computing system 100 configured to provide cloud services in accordance with embodiments of the disclosed technology. As shown in FIG. 1, the computing system 100 can include an underlay network 108 interconnecting a plurality of hosts 106, a plurality of tenants 101, and a designer server 126. Even though particular components of the computing system 100 are shown in FIG. 1, in other embodiments, the computing system 100 can also include additional and/or different components. For example, in certain embodiments, the computing system 100 can also include network storage devices, maintenance managers, and/or other suitable components (not shown).

As shown in FIG. 1, the underlay network 108 can include one or more network nodes 112 that interconnect the multiple hosts 106, the tenants 101, and the designer server 126. In certain embodiments, the hosts 106 can be organized into racks, action zones, groups, sets, or other suitable divisions. For example, in the illustrated embodiment, the hosts 106 are grouped into three host sets identified individually as first, second, and third host sets 107a-107c. In the illustrated embodiment, each of the host sets 107a-107c is operatively coupled to a corresponding network nodes 112a-112c, respectively, which are commonly referred to as “top-of-rack” or “TOR” network nodes. The TOR network nodes 112a-112c can then be operatively coupled to additional network nodes 112 to form a computer network in a hierarchical, flat, mesh, or other suitable types of topology that allows communication between hosts 106, the designer server 126, and the tenants 101. In other embodiments, multiple host sets 107a-107c may share a single network node 112.

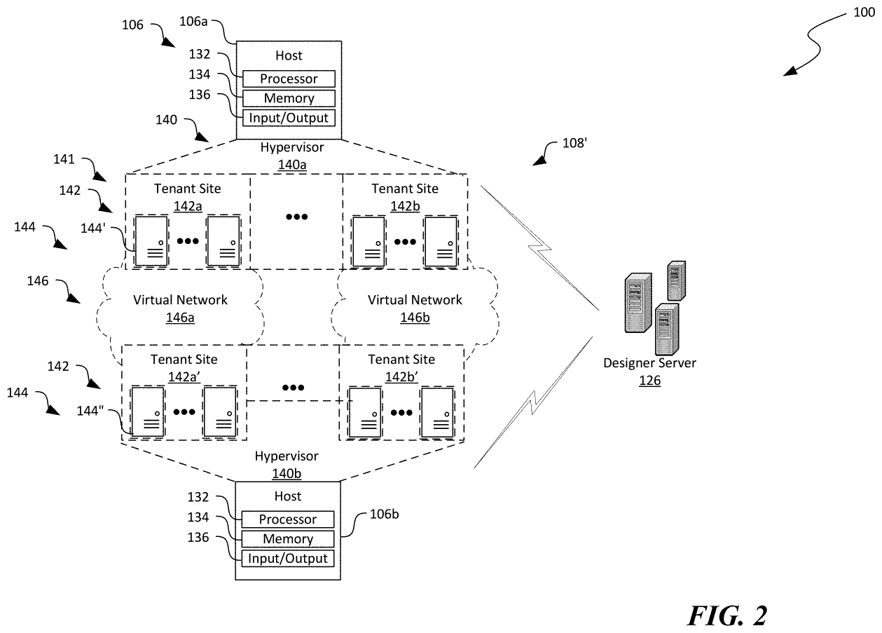

The hosts 106 can individually be configured to provide computing, storage, and/or other suitable cloud computing services to the tenants 101. For example, as described in more detail below with reference to FIG. 2, one of the hosts 106 can initiate and maintain one or more virtual machines 144 (shown in FIG. 2) upon requests from the tenants 101. The tenants 101 can then utilize the initiated virtual machines 144 to perform computation, communications, and/or other suitable tasks. In certain embodiments, one of the hosts 106 can provide virtual machines 144 for multiple tenants 101. For example, the host 106′ can host three virtual machines 144 individually corresponding to each of the tenants 101a-101b.

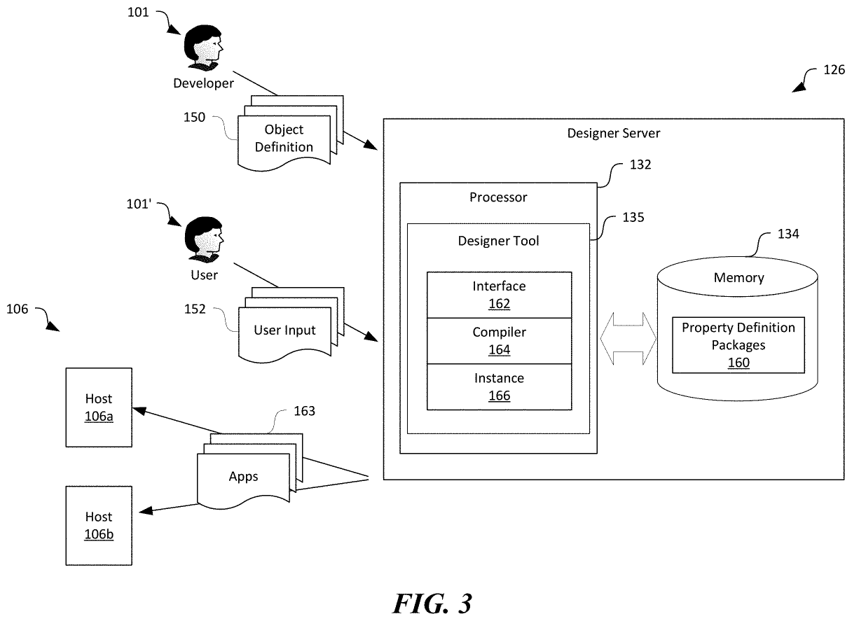

In accordance with several embodiments of the disclosed technology, the designer server 126 can be configured to provide a designer tool 135 (shown in FIG. 3) based on graphical object-oriented programming for creating, deploying, or managing cloud computing apps. As used herein, the terms “cloud computing apps” or “apps” generally refer to computer applications designed to be executed by remote computing facilities (e.g., datacenters) and provide services accessible via computer networks (e.g., the Internet). In certain embodiments, the designer server 126 can be a standalone server operatively coupled to the underlay network 108. In other embodiments, the designer server 126 can be implemented as one or more cloud computing services executing on and provided by, for example, one or more of the hosts 106. Example components of the designer server 126 and designer tool 135 are described in more detail below with reference to FIG. 3.

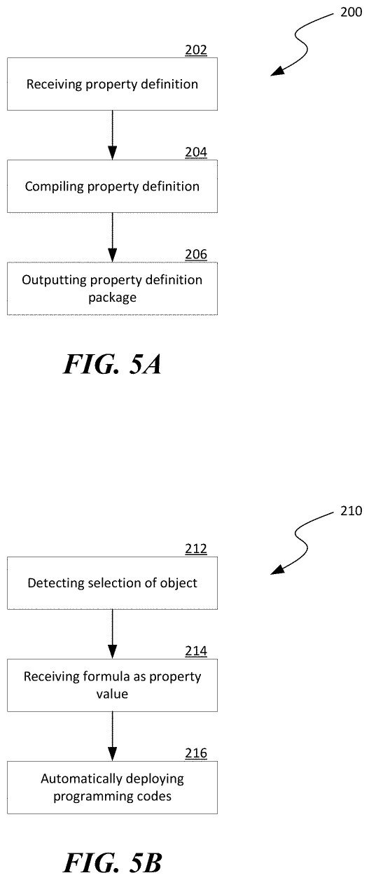

FIG. 2 is a schematic diagram illustrating an overlay network 108′ implemented on the underlay network 108 of FIG. 1 in accordance with embodiments of the disclosed technology. In FIG. 2, only certain components of the underlay network 108 of FIG. 1 are shown for clarity. As shown in FIG. 2, the first host 106a and the second host 106b can each include a processor 132, a memory 134, and an input/output component 136 operatively coupled to one another. The processor 132 can include a microprocessor, a field-programmable gate array, and/or other suitable logic devices. The memory 134 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 132 (e.g., instructions for performing the methods discussed below with reference to FIG. 5). The input/output component 136 can include a display, a touch screen, a keyboard, a mouse, a printer, and/or other suitable types of input/output devices configured to accept input from and provide output to an operator and/or an automated software controller (not shown).

The memory 134 of the first and second hosts 106a and 106b can contain instructions executable by the processors 132 to cause the individual processors 132 to provide a hypervisor 140 (identified individually as first and second hypervisors 140a and 140b) and other suitable components (not shown). The hypervisors 140 can individually be configured to generate, monitor, terminate, and/or otherwise manage one or more virtual machines 144 organized into tenant sites 142. For example, as shown in FIG. 2, the first host 106a can provide a first hypervisor 140a that manages first and second tenant sites 142a and 142b, respectively. The second host 106b can provide a second hypervisor 140b that manages first and second tenant sites 142a′ and 142b′, respectively. The hypervisors 140 can be software, firmware, or hardware components. The tenant sites 142 can each include multiple virtual machines 144 for a particular tenant (not shown). For example, the first host 106a and the second host 106b can both host the tenant site 142a and 142a′ for a first tenant 101a (FIG. 1). The first host 106a and the second host 106b can both host the tenant site 142b and 142b′ for a second tenant 101b (FIG. 1). Each virtual machine 144 can be executing a corresponding operating system, middleware, and/or applications.

Also shown in FIG. 2, the computing system 100 can include an overlay network 108′ having one or more virtual networks 146 that interconnect the tenant sites 142a and 142b across multiple hosts 106. For example, a first virtual network 142a interconnects the first tenant sites 142a and 142a′ at the first host 106a and the second host 106b. A second virtual network 146b interconnects the second tenant sites 142b and 142b′ at the first host 106a and the second host 106b. Even though a single virtual network 146 is shown as corresponding to one tenant site 142, in other embodiments, multiple virtual networks 146 (not shown) may be configured to correspond to a single tenant site 146.

The virtual machines 144 on the virtual networks 146 can communicate with one another via the underlay network 108 (FIG. 1) even though the virtual machines 144 are located on different hosts 106. Communications of each of the virtual networks 146 can be isolated from other virtual networks 146. In certain embodiments, communications can be allowed to cross from one virtual network 146 to another through a security gateway or otherwise in a controlled fashion. A virtual network address can correspond to one of the virtual machines 144 in a particular virtual network 146. Thus, different virtual networks 146 can use one or more virtual network addresses that are the same. Example virtual network addresses can include IP addresses, MAC addresses, and/or other suitable addresses.

FIG. 3 is a schematic block diagram illustrating certain hardware/software components of the designer server 126 and designer tool 135 suitable in the computing system 100 shown in FIGS. 1 and 2 in accordance with embodiments of the disclosed technology. In FIG. 3 and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads).

Components within a system may take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry. A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 3, the designer server 126 can include a processor 131 operatively coupled to a memory 150 containing records of property definition packages 160. The processor 131 of the designer server 126 can execute instructions to provide various components of the designer tool 135. For example, as shown in FIG. 3, the designer tool 135 can include an interface component 162, a compiler 164, and an instance component 166 operatively coupled to one another. Even though only particular components of the designer tool 135 are shown in FIG. 3, in further embodiments, the designer tool 135 can also include database, communications, or other suitable types of components.

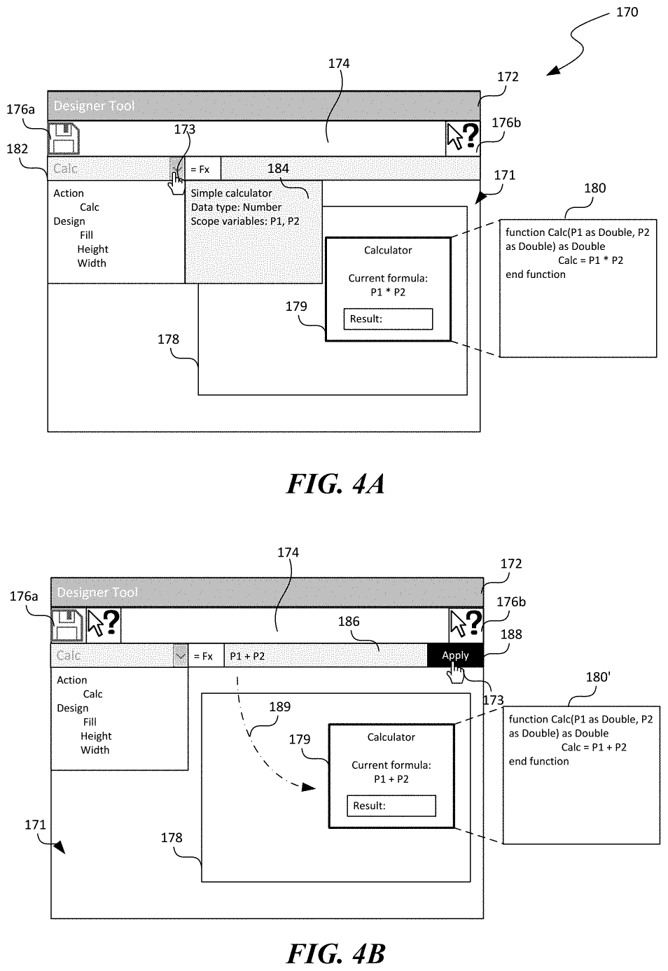

In the illustrated embodiment, the interface component 162 can be configured to provide facilities, such as a graphical user interface, for receiving object definition 150 from a developer 101 and user input 152 from the user 101′. The interface component 162 can also be configured to provide any created apps 163 to the hosts 106 for execution. In certain embodiments, the interface component 162 can include a network interface driver and associated applications. In other embodiments, the interface component 162 can also include other suitable components. One example graphical user interface is described in more detail below with reference to FIGS. 4A and 4B.

In certain implementations, the interface component 162 can be configured to provide galleries, menu items, dropdown lists, or other suitable types of interface elements that allow the developer 101 to select, organize, and configure various elements of an object that can then be used as a template by the user 101′. For example, the interface component 162 can provide a dropdown list that provides various labels, buttons, images, or other interface elements for selection by the developer 101. Using the dropdown list, the developer 101 can insert, arrange, or otherwise manipulate the various interface elements as sub-objects of the object. In other implementations, the interface component 162 can provide a text based or other suitable types of programming interface.

The interface component 162 can also provide facilities for customizing properties of the object by allowing the developer 101 to define one or more properties of the object. For instance, the interface component 162 can provide various input fields of a property upon receiving a user command. The input fields can include, for example, a description field, a type field, a default value field, a default formula field, or other suitable input fields. In certain implementations, the type field can include options to select an “input,” “output,” or another suitable type for a property. An input type indicates to the designer tool 135 that the property can have a value received from an application scope. An output type indicates to the designer tool 135 that the property can have a value outputted to the application scope.

In accordance with embodiments of the disclosed technology, the property can have a value that represents a command that is executed in the application upon actuation. In other embodiments, the interface component 162 can also provide facilities that allow the developer 101 to select one or more input parameters of the property in the object scope to be exposed to the application scope. For example, the developer 101 can designate that a first input parameter in the object scope is exposed to the application scope while a second input parameter is not exposed to the application scope. The first input parameter exposed to the application scope can be used by the user 101′ when composing the formula in the application scope, as described in more detail below with reference to FIGS. 4A and 4B. In other embodiments, the interface component 162 can also allow the developer 101 to enter a default formula for the property.

Upon receiving the object definition 150, the compiler 164 can be configured to compile the received object definition 150 into a property definition package 160 and store the property definition package 160 in the memory 134. In certain implementations, compiling the object definition 150 can include generating programming codes of a function corresponding to property. For instance, the developer 101 can specify a name (e.g., “Calc”) of the property for an instance of the object, defining one or more input parameters (e.g., P1 and P2) of the property, and provide a default formula for the property (e.g., P1*P2) using the graphical user interface provided by the interface component 162. Based on the received object definition 150, the compiler 164 can then be configured to automatically declare a function and the defined input parameters, identity the input parameters as values to be passed to the function for evaluation, optional actions to be performed within the function, and one or more values to be returned when the function is called. The following are examples codes for a function corresponding to the example “Calc” property above:

function Calc(P1 as Double, P2 as Double) as Double Calc=P1*P2 end function

As shown above, the declared function has a name “Calc” that takes two input parameters, i.e., “P1” and “P2” both of which are Double number; and returns a Double number that equals to P1*P2 representing the default formula.

The instance component 166 of the designer tool 135 can be configured to facilitate creation or modification of the apps 163 by the user 101′ using the property definition packages 160 in the memory 134. For example, the interface component 162 can provide a graphical user interface that allows the user 101′ to provide user input 152 to select a property definition package 160 and create an instance of the object corresponding to the property definition package 160. The instance component 166 can also be configured to received additional user input 152 that represent a formula as a property value to the property of the instance of the object and automatically extend the instance of the object with a function that incorporates the formula. The Instance component 166 can also be configured to allow the instance of the object to perform a call back of the function in order to execute the function, as discussed in more detail below with reference to FIGS. 4A and 4B.

FIGS. 4A and 4B are schematic diagrams of a graphical user interface 170 suitable for the designer tool 135 in FIG. 3 in accordance with embodiments of the disclosed technology. As shown in FIG. 4A, the graphical user interface 170 can include a title bar 172, a menu bar 174 having various menu icons (e.g., “save” 176a and “help” 176b shown in FIG. 4A for illustration purposes). The graphical user interface 170 can also include a working area 171 (sometimes referred to as a “canvas”) in which a user 101′ (FIG. 3) can create a cloud computing app 163 (FIG. 3) using various graphical objects 177 from, for instance, an object template (not shown) and the property definition packages 160 (FIG. 3).

In the example shown in FIG. 4A, the graphical objects 177 include a page 178 of an app 163 that contains a graphical representation of an object 179. As shown in FIG. 4A, the object 179 is shown as a block representing a calculator having a property “Calc” that has two input parameters (e.g., P1 and P2) and a default formula of P1*P2. The block representing the calculator also includes an output field that outputs a calculator result. As described above with reference to FIG. 3, the object 179 can correspond to programming codes 180 that represent a function corresponding to the “Calc” property of the object 179. For instance, as shown in FIG. 4A, the programming codes 180 can include the formula discussed above with reference to FIG. 3.

The graphical user interface 170 can also be configured to provide facilities for the user 101′ to access input parameters of the “Calc” property internal to the object 179 from the application scope. For instance, the graphical user interface 170 can show a dropdown menu 182 upon detecting that the object 179 is selected (shown with thick borders). The dropdown menu 182 can be configured to show various properties or attributes of the object 179 upon actuation, such as a click 173. In the illustrated example, the dropdown menu 182 shows that the object 179 has a property “Calc” as well as various design attributes such as “Fill,” “Height,” and “Width.”

The graphical user interface 170 can also be configured to surface additional information of the object in, for instance, a balloon, popup window, or other types of suitable interface element. As such shown in FIG. 4A, the balloon 184 shows a description of the object (i.e., “Simple calculator”), a data type of the output (i.e., “Number”), as well as object scope input parameters that are accessible from the application scope (i.e., “P1” and “P2”). In other examples, the balloon 184 can also be configured to output the default formula of the object 179 or other suitable information.

As shown in FIG. 4B, the graphical user interface 170 can also be configured to provide an input field 186 that allows the user 101′ to enter a new formula using the object scope variables (e.g., “P1” and “P2”), one or more application scope variables (not shown), and/or commands (not shown). For instance, in the illustrated example, the user 101′ enters a new formula “P1+P2” into the input field 186. Upon detecting a confirmation by the user 101′, for instance, by detecting a click 171 on the “Apply” button 188, the instance component 166 (FIG. 3) can be configured to automatically extend the instance 179 with a function that incorporates the new formula (as represented by the arrow 189). For example, the instance component 166 can be configured to replace the default formula (i.e., “P1*P2”) with the new formula (“P1+P2”). In other examples, the instance component 166 can insert the new formula into the function when no default formula exists and/or perform other suitable operations to incorporate the new formula into the programming codes 180.

Several embodiments of the disclosed technology can thus allow the user 101′ to program desired functions by extending properties of the object 179. Instead of requiring a user to have certain programming skills or knowledge of declaring a function and input parameters, passing arguments to the function, and receiving results back from the function, the user 101′ simply inputs a desired formula having various input parameters at the object scope as a value to the “Calc” property of the object 179. As such, programming concepts of function such as declaring parameters and return types may be avoided in order to implement the desired function.

Though the operations described above with reference to FIGS. 1-4B are in the context of the developer 101 and the user 101′, in other embodiments, the user 101′ can also utilize the graphical user interface 170 to create new property definition packages 160 (FIG. 3) and corresponding instances of the objects 179. In further embodiments, the property definition packages 160 can be generated by other suitable entities (e.g., providers of the designer tool 170). In yet further embodiments, the graphical user interface 170 can be configured to allow the user 101′ to enter multiple formulas to be applied to the object 179.

FIGS. 5A and 5B are flowcharts illustrating processes of extending properties of objects in an app in accordance with embodiments of the disclosed technology. Though the processes described below are in the context of the computing system 100 of FIG. 1, embodiments of the processes can be implemented in other computing systems with additional and/or different components.

As shown in FIG. 5A, a process 200 can include receiving a property definition at stage 202. In one embodiment, the property definition can be received from a developer via a graphical user interface. In other embodiments, the property definition can be received from other suitable entities via a programming editor or other suitable interfaces. The process 200 can then include compiling the received property definition into a property definition package at stage 204. In one embodiment, compiling the received property definition can include automatically declaring a function and the defined input parameters of the function, identifying the input parameters as values to be passed to the function for evaluation, inserting optional actions to be performed within the function, and identifying one or more values to be returned when the function is called. In other embodiments, compiling the received property definition can include other suitable operations. The process 200 can then include outputting the compiled property definition as property definition package at stage 206.

As shown in FIG. 5B, a process 210 can include detecting a selection of an object at stage 212. The selection of the object can be detected by identifying a click, touch, or other suitable types of input on a graphical or other type of representation of the object. The process 210 can then include receiving a formula as a property value to a property of the object at stage 214. The formula can include input parameters of the property defined in the object scope. The process 210 can then include automatically extend the object to incorporate the received formula having the input parameters at stage 216. One example of receiving such a formula and extending the object accordingly is described above with reference to FIG. 4B.

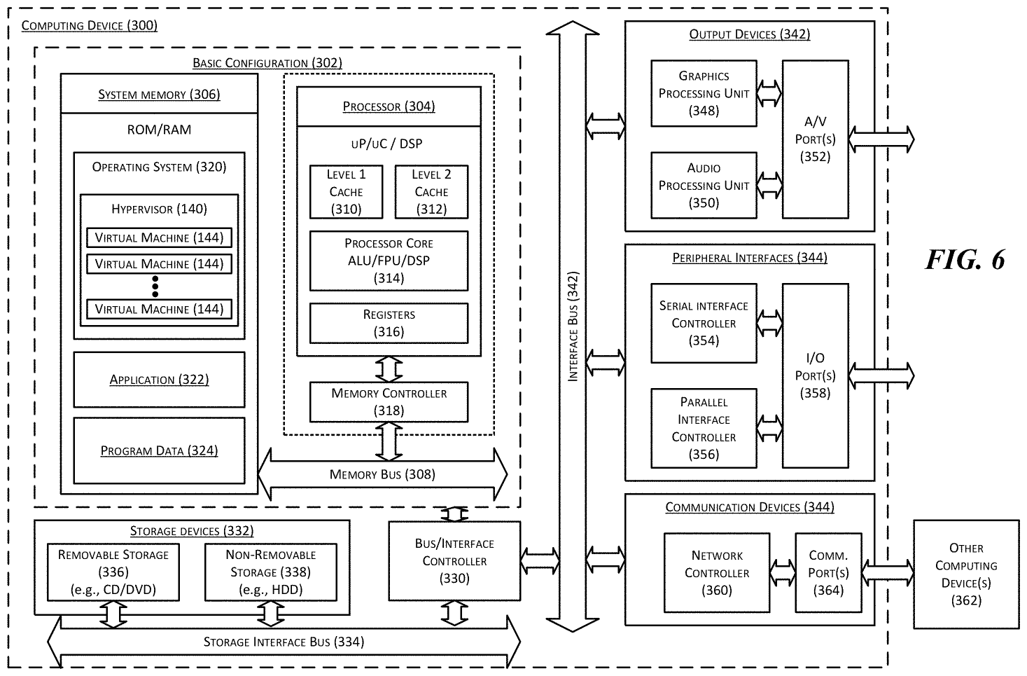

FIG. 6 is a computing device 300 suitable for certain components of the computing system 100 in FIG. 1. For example, the computing device 300 can be suitable for the hosts 106 or the designer server 126 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. As shown in FIG. 6, the operating system 320 can include a hypervisor 140 for managing one or more virtual machines 144. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method of extending properties of objects in a designer tool executed on a computing device, the method comprising:
detecting an input selecting an instance of an object of an application surfaced via a graphical user interface of the designer tool, the object including a property having an input parameter defined in the object; and
upon detecting the input selecting the instance of the object,
receiving, via the graphical user interface of the designer tool, a formula as an input value to the property of the instance of the object surfaced via the graphical user interface of the designer tool, the received formula containing the input parameter of the property; and
in response to receiving the formula as the input value to the property,
automatically extending, at the designer tool, the instance of the object corresponding to the property by translating the received formula containing the input parameter of the property into a function executable in the application;
calling, with the instance of the object, the function with a value for the input parameter provided by the instance of the object; and
receiving, at the instance of the object, a return value from evaluation of the function with the provided value for the input parameter, thereby allowing ready implementation of the formula in the function via the property of the instance of the object.

2. The method of claim 1, further comprising:
surfacing, at an application scope, an option to select the input parameter that is at an object scope of the instance of the object in the graphical user interface; and
wherein receiving the formula includes detecting a selection of the input parameter and incorporating the variable as a part of the received formula at the object scope.

3. The method of claim 1, further comprising:
surfacing, at an application scope, an option to select the input parameter that is at an object scope of the instance of the object and a global variable that is at an application scope in the graphical user interface; and
wherein receiving the formula includes detecting a selection of the input parameter and the global variable and incorporating both the input parameter and the global variable as a part of the received formula at the object scope.

4. The method of claim 1 wherein:
the function corresponding to the property in the instance of the object includes a default formula; and
automatically extending includes, at the designer tool, substituting the default formula with the formula received as the input value to the property.

5. The method of claim 1 wherein receiving the formula includes receiving a formula corresponding to a command that performs an action upon each invocation.

6. The method of claim 1 wherein receiving the formula includes receiving a formula that is invokable by the instance of the object upon providing a value to the input parameter of the function.

7. The method of claim 1 wherein:
the instance is a first instance of the object;
the received formula is a first formula; and
the method further includes:
upon detecting another input selecting a second instance of the same object in the application,
receiving, via the graphical user interface of the designer tool, a second formula as an input value to the property of the second instance of the object, the second formula being different than the first formula; and
in response to receiving the second formula as the input value to the property, automatically deploying, at the designer tool, programming codes of the function of the second instance of the object to incorporate the second formula into the function in the second instance of the object.

8. The method of claim 1 wherein:
the object includes multiple sub-objects contained in a template; and
the method further includes inserting a graphical representation of the instance of the object containing the multiple sub-objects onto the graphical user interface based on the template upon receiving a command to add the instance of the object from a template of the object.

9. The method of claim 1 wherein:
the object includes multiple sub-objects;
the instance of the object is a first instance of the object;
the application includes a second instance of the same object; and
the method further includes:
receiving a modification to a template of the object in the designer tool; and
in response to receiving the modification, automatically applying the received modification to both the first and second instances of the object.

10. A computing device for facilitating creation of a cloud computing application, the computing device comprising:
a processor;
a memory operatively coupled to the processor, the memory containing instructions executable by the processor to provide a graphical user interface of a designer tool, the memory including additional instructions executable by the processor to cause the computing device to:
receive, via the graphical user interface of the designer tool, a formula as an input value to a property of an instance of an object in an application surfaced via the graphical user interface of the designer tool, the property having an input parameter defined in the object, wherein the received formula includes the input parameter; and
in response to receiving the formula as the input value to the property,
automatically deploy programming codes of a function in the application to incorporate the formula received as the input value to the property;
calling, with the instance of the object, the function with a value for the input parameter provided by the instance of the object; and
receiving, at the instance of the object, a return value from evaluation of the function with the provided value for the input parameter, thereby allowing ready implementation of the formula in the function via the property of the instance of the object as an extension to the instance of the object.

11. The computing device of claim 10 wherein the memory includes further instructions executable by the processor to cause the computing device to surface, at an application scope, an option to select the input parameter that is at an object scope of the instance of the object in the graphical user interface, and wherein to receive the formula includes to detect a selection of the input parameter to the instance and incorporate the selected input parameter as a part of the received formula at the object scope.

12. The computing device of claim 10 wherein the memory includes further instructions executable by the processor to cause the computing device to:
surface, at an application scope, an option to select the input parameter that is at an object scope of the instance of the object and a global variable that is at an application scope in the graphical user interface; and
wherein to receive the formula includes to detect a selection of the input parameter and the global variable and incorporate both the input parameter and the global variable as a part of the received formula at the object scope.

13. The computing device of claim 10 wherein:
the function in the instance of the object includes a default formula; and
to automatically deploy includes to substitute the default formula with the formula received as the input value to the property.

14. The computing device of claim 10 wherein the formula includes a formula corresponding to a command that repeats an action upon each invocation.

15. The computing device of claim 10 wherein the formula includes a formula that is invokable by the instance of the object upon providing the value to the input parameter of the function.

16. The computing device of claim 10 wherein:
the instance is a first instance of the object;
the received formula is a first formula; and
the memory includes further instructions executable by the processor to cause the computing device to:
upon detecting another input selecting a second instance of the same object in the application,
receive, via the graphical user interface of the designer tool, a second formula as an input value to the property of the second instance of the object, the second formula being different than the first formula; and
in response to receiving the second formula as the input value to the property, automatically deploy, at the designer tool,
programming codes of the second instance of the object to incorporate the second formula into the function embedded in the second instance of the object.

17. A method of extending functions of objects via object properties in a designer tool executed on a computing device, the method comprising:
surfacing, via a graphical user interface of an application in the designer tool, a graphical representation of an instance of an object in the application based on a template, the object having a property having an input parameter defined in the object; and
upon detecting an input selecting the graphical representation of the instance of the object on the graphical user interface of the application,
surfacing, at the graphical user interface, the input parameter of the property internal to the instance of the object;
receiving, via an input field on the graphical user interface of the designer tool, a formula as an input value to the property of the instance of the object, the formula containing the surfaced input parameter of the property in the instance of the object; and
in response to receiving the formula as the input value to the property,
deploying, at the designer tool, a function corresponding to the property of the instance of the object to incorporate the formula received as the input value to the property;
calling, with the instance of the object, the function with a value for the input parameter provided by the instance of the object; and
receiving, at the instance of the object, a return value from evaluation of the function with the provided value for the input parameter, thereby allowing ready implementation of the formula via the property of the instance of the object as an extension to the instance of the object.

18. The method of claim 17 wherein:
the function embedded in the instance of the object includes a default formula; and
deploying includes, deploying the designer tool, substituting the default formula with the formula received as the input value to the property.

19. The method of claim 17 wherein receiving the formula includes receiving a formula corresponding to a command that repeats an action upon each invocation.

20. The method of claim 17 wherein:
the instance is a first instance of the object;
the received formula is a first formula; and
the method further includes:
upon detecting another input selecting a second instance of the same object in the application,
receiving, via the graphical user interface of the designer tool, a second formula as an input value to the property of the second instance of the object, the second formula being different than the first formula; and
in response to receiving the second formula as the input value to the property, automatically deploying, at the designer tool, programming codes of the second instance of the object to incorporate the second formula into the function embedded in the second instance of the object.
